(19) United States
(12) Patent Application Publication
(10) Pub. No.: US 2008/0305825 A1
(43) Pub. Date: Dec. 11, 2008

(54) METHOD AND APPARATUS FOR PROVIDING CAPABILITY AND CORE NETWORK INFORMATION TO SUPPORT INTERWORKING BETWEEN 3GPP AND NON-3GPP NETWORKS

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/132,902

(22) Filed: Jun. 4, 2008

Related U.S. Application Data
(60) Provisional application No. 60/942,672, filed on Jun. 8, 2007.
(60) Provisional application No. 60/942,771, filed on Jun. 8, 2007.
(60) Provisional application No. 60/942,780, filed on Jun. 8, 2007.

(51) Int. Cl. H04M 1/00

(52) U.S. Cl. 455/552.1

(57) ABSTRACT

A method and apparatus for providing capability information and core network information to support interworking between a third generation partnership project (3GPP) network and a non-3GPP network are disclosed. A user equipment (UE) sends UE capability information pertaining to the non-3GPP network such as IEEE 802.11 interworking wireless local area network (I-WLAN), an IEEE 802.16 WiMAX network, a fixed broadband network, etc. to a 3GPP network. The 3GPP network may send core network information pertaining to the non-3GPP networks to the UE.

### CROSS REFERENCE TO RELATED APPLICATIONS

This application claims the benefit of U.S. provisional application Nos. 60/942,672 file Jun. 8, 2007, 60/942,771 filed Jun. 8, 2007, and 60/942,780 filed Jun. 8, 2007, which are incorporated by reference as if fully set forth.

### FIELD OF INVENTION

This application is related to wireless communications.

### BACKGROUND

Currently the mobile Communication industry is moving toward convergence and interworking between various wireless technologies, (e.g., third generation partnership project (3GPP)-based, 3GPP2-based, IEEE 802.11 WiFi, IEEE 802.16 WiMax, and Fixed Broadband Access, etc.). The main goal of this convergence is to allow subscribers to access their home-based services anywhere via any technology. In order to support this goal, the 3GPP standards have defined the interworking architecture, (i.e., evolved packet system (EPS)), shown in FIG. 1.

The functions of the mobility management entity (MME) include non-access stratum (NAS) signaling and security, inter core network (CN) node signaling for mobility between 3GPP access networks, roaming, authentication, or the like. The serving gateway is a note that terminates the interface towards an evolved universal terrestrial radio access network (EUTRAN). The packet data network (PDN) gateway is a node that terminates the SGi interface towards the PDN. The functions of the PDN gateway include mobility anchor for mobility between 3GPP network and non-3GPP networks, UE Internet protocol (IP) address allocation, etc.

For non-3GPP accesses, the EPS includes an evolved packet data gateway (ePDG). The ePDG includes functionalities of a PDG according to 3GPP standards that specify inter-working between 3GPP systems and a WLAN. Untrusted non-3GPP access requires ePDG in the data path.

To support roaming and mobility, the EPS architecture defines following interfaces:

S1-MME, S1-U, S3, S4, S10, S11: These are defined in 3GPP TS 23.401.

S2a: It provides a user plane with related control and mobility support between a trusted non-3GPP IP access and a gateway.

S2b: It provides a user plane with related control and mobility support between an ePDG and a gateway.

S2c: It provides a user plane with related control and mobility support between a user equipment (UE) and a gateway. This reference point is implemented over trusted and/or untrusted non-3GPP access and/or 3GPP access.

S5: It provides user plane tunneling and tunnel management between a serving gateway and a packet data network (PDN) gateway. It is used for serving gateway relocation due to UE mobility and in case the serving gateway needs to connect to a non-collocated PDN GW for the required PDN connectivity.

S6a: This interface is defined between an MME and a home subscriber server (HSS) for authentication and authorization.

S6c: It is a reference point between a PDN gateway in a home public land mobile network (HPLMN) and a 3GPP authentication, authorization and accounting (AAA) server for mobility related authentication if needed. This reference point may also be used to retrieve and request storage of mobility parameters.

S6d: It is a reference point between a serving gateway in a visited public land mobile network (VPLMN) and a 3GPP AAA proxy for mobility related authentication if needed. This reference point may also be used to retrieve and request storage of mobility parameters.

S7: It provides transfer of quality of service (QoS) policy and charging rules from a PCRF to a policy and charging enforcement point (PCEF).

S8b: It is a roaming interface in case of roaming with home routed traffic. It provides a user plane with related control between gateways in the VPLMN and the HPLMN.

S9: It indicates the roaming variant of the S7 reference point for the enforcement in the VPLMN of dynamic control policies from the HPLMN.

SGi: It is a reference point between a PDN gateway and a packet data network. The packet data network may be an operator external public or private packet data network or an intra operator packet data network, (e.g., for provision of IP multimedia subsystem (IMS) services). This reference point corresponds to Gi and Wi functionalities and supports any 3GPP and non-3GPP access systems.

Wa: It connects an untrusted non-3GPP IP access with a 3GPP AAA server/proxy and transports access authentication, authorization and charging-related information in a secure manner.

Ta: It connects a trusted non-3GPP IP access with a 3GPP AAA server/proxy and transports access authentication, authorization, mobility parameters and charging-related information in a secure manner.

Wd: It connects the 3GPP AAA proxy, possibly via intermediate networks, to the 3GPP AAA server.

Wm: This reference point is located between a 3GPP AAA server/proxy and an ePDG and is used for AAA signaling (transport of mobility parameters, tunnel authentication and authorization data).

Wn: This is a reference point between an untrusted non-3GPP IP access and an ePDG. Traffic on this interface for a UE initiated tunnel has to be forced towards the ePDG.

Wx: This reference point is located between a 3GPP AAA server and an HSS and is used for transport of authentication data.

In order to perform interworking operation effectively between 3GPP systems and non-3GPP systems, it would be desirable to exchange information pertaining to different systems between a UE and a network.

### SUMMARY

A method and apparatus for providing capability information and core network information to support interworking between a 3GPP network and a non-3GPP network are disclosed. A UE sends UE capability information pertaining to the non-3GPP network such as IEEE 802.11 interworking wireless local area network (I-WLAN), an IEEE 802.16 WiMAX network, a fixed broadband network, etc. to a 3GPP network. The 3GPP network may send core network information pertaining to the non-3GPP networks to the UE.

### BRIEF DESCRIPTION OF THE DRAWINGS

A more detailed understanding may be had from the following description, given by way of example in conjunction with the accompanying drawings wherein:

FIG. 1 an interworking architecture defined by the 3GPP standards;

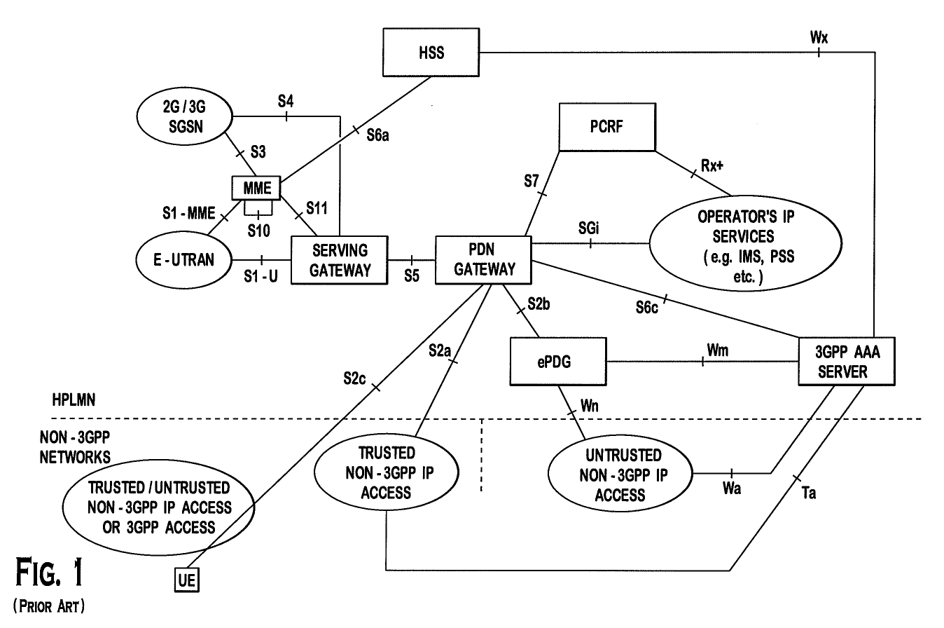

FIG. 2 shows a UE including multiple radio units for operating both in a 3GPP network and a non-3GPP network; and

FIG. 3 is a flow diagram of a process of exchanging UE capability information and core network information pertaining to the non-3GPP network.

### DETAILED DESCRIPTION

When referred to hereafter, the terminology “UE” includes but is not limited to a wireless transmit/receive unit (WTRU), a mobile station, a fixed or mobile subscriber unit, a pager, a cellular telephone, a personal digital assistant (PDA), a computer, or any other type of user device capable of operating in a wireless environment.

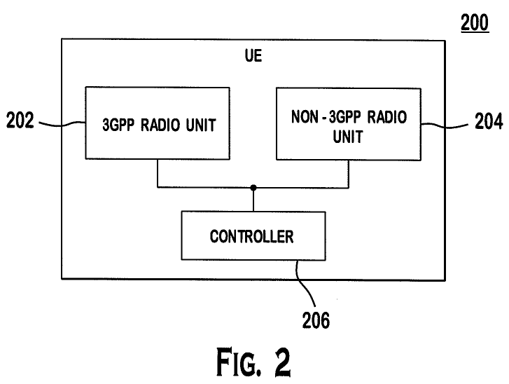

FIG. 2 shows a UE 200 including multiple radio units for operating both in a 3GPP network and a non-3GPP network. The UE 200 includes multiple radio units, (i.e., a 3GPP radio unit 202 and at least one non-3GPP radio unit 204). A controller 206 in the UE 200 controls the radio units 202, 204 and performs functions for handover between the 3GPP network and the non-3GPP network. The non-3GPP network may be an IEEE 802.11 interworking wireless local area network (I-WLAN), an IEEE 802.16 WiMAX network, a fixed broadband network, or the like.

The UE 200 and the 3GPP network exchange UE capability information and core network information in order to facilitate the handover between the 3GPP network and the non-3GPP network. The 3GPP standards define UE capability information and core network information to be exchanged between the UE and the 3GPP network for facilitating communication within the 3GPP network (3GPP TS 25.331). The conventional 3GPP information elements are extended to provide UE capability information and core network information pertaining to the non-3GPP networks to facilitate interworking between the 3GPP network and the non-3GPP network.

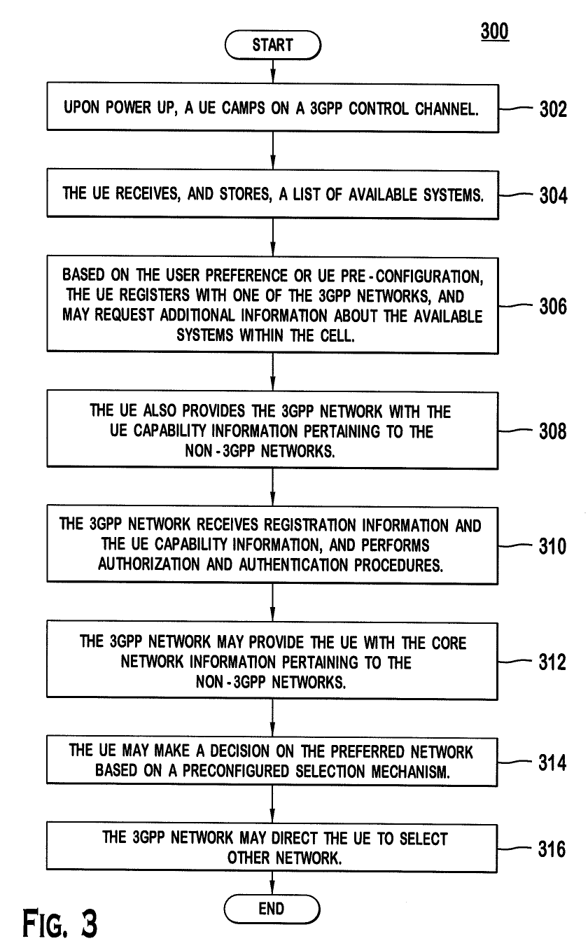

FIG. 3 is a flow diagram of an example process 300 of exchanging UE capability information and core network information pertaining to the non-3GPP network. It should be noted that the steps in the process 300 may be performed in different order and some steps may be performed simultaneously or may be omitted. Upon power up, a UE camps on a 3GPP control channel (step 302). Information regarding available systems within a cell, (e.g., GSM, GPRS, UMTS, or the like), is transmitted via the 3GPP control channel. The UE receives, and stores, a list of available systems (step 304).

Based on the user preference or UE pre-configuration, the UE registers with one of the 3GPP networks, and may request additional information about the available systems within the cell (step 306). The UE also provides the 3GPP network with the UE capability information pertaining to the non-3GPP networks (step 308). The UE capability information pertaining to the non-3GPP network includes UE multi-mode/multi-radio access technology (RAT) capability, UE radio access capability, UE measurement capability, or the like, which will be described in detail below.

The 3GPP network receives registration information and the UE capability information, and performs authorization and authentication procedures to ensure the integrity of the information provided by the UE (step 310). The 3GPP network may provide the UE with the core network information pertaining to the non-3GPP networks (step 312). The core network information may include at least one of core network domain identity, core network domain system information, domain specific access restriction, domain specific access restriction parameters, intra domain non-access stratum (NAS) node selector, NAS system information, public land mobile network (PLMN) type, and radio access bearer (RAB) identity, etc., which will be described in detail below. The 3GPP network may also provide the UE with the core network capability information.

After receiving the core network information, the UE may make a decision on the preferred network based on a preconfigured selection mechanism (step 314). The 3GPP network may direct the UE to select other network (step 316).

The UE sends UE multi-mode/multi-RAT capability information (defined in 3GPP TS 25.331 10.3.3.41) to the 3GPP network. Information pertaining to the non-3GPP network is added to the UE multi-mode/multi-RAT capability information. The new information includes at least one of support of trusted interworking wireless local area network (I-WLAN), support of untrusted I-WLAN, support of WiMAX (trusted), support of fixed broadband (trusted), support of I-WLAN-UTRAN handoffs, support of WiMAX-UTRAN handoffs, support of fixed broadband-UTRAN handoffs, etc. Table 1 shows UE multi-mode/multi-RAT capability information including these new information elements (underlined) pertaining to the non-3GPP technologies. In the need column tables below, MP stands for mandatory present and OP stands for optional.

TABLE 1

| Information Element/Group name | Need | Type and Reference | Version |
|---|---|---|---|
| Multi-RAT capability | | | |
| Support of GSM | MP | Boolean | |
| Support of multi-carrier | MP | Boolean | |
| Multi-mode capability | MP | Enumerated (TDD, FDD, | |
| | | FDD/TDD) | |
| Support of UTRAN to GERAN NACC | CV- | Boolean | REL-5 |
| | not_iRAT_Ho | | |
| | Info | | |
| Support I-WLAN (Trusted) | MP | Enumerated (802.11b, | REL 7/8 |
| | | 802.11g, 802.11n) | |
| Support I-WLAN (Non-Trusted) | MP | Enumerated (802.11b, | REL 7/8 |
| | | 802.11g, 802.11n) | |
| Support WiMAX (Trusted) | MP | Enumerated (802.16e) | REL 6/7 |
| Support Fixed Broadband (Trusted) | MP | Enumerated( ) | REL 6/7 |
| Support I-WLAN UTRAN handoffs | | Boolean | |
| Support WiMAX UTRAN handoffs | | Boolean | |
| Support Fixed Broadband UTRAN handoffs | | Boolean | |

| Condition | Explanation |
|---|---|
| not_iRAT_HoInfo | The IE is not needed in the INTER RAT HANDOVER |
| | INFO message. Otherwise, it is mandatory present. |

The UE reports UE radio access capability information (defined in 3GPP TS 25.331 10.3.3.42). Information pertaining to the non-3GPP network is added to the UE radio access capability information. For example, the new information may be at least one of I-WLAN radio frequency (RF) capability, WiMAX RF capability, fixed broadband RF capability, etc. Table 2 shows UE radio access capability information including the new information elements (underlined) pertaining to the non-3GPP technologies.

TABLE 2

| Information | | | | | |
|---|---|---|---|---|---|
| Element/Group | | | Type and | | |
| name | Need | Multi | reference | Semantics description | Version |
| Access stratum | MP | | Enumerated(R99) | Indicates the release of the UE | |
| release indicator | | | | according to [35]. The IE also | |
| | | | | indicates the release of the | |
| | | | | RRC transfer syntax supported | |
| | | | | by the UE. | |
| | CV- | | Enumerated(REL- | 13 spare values are needed. | REL-4 |
| | not_rrc_connection | | 4, | | |
| | Setup | | REL-5 | | REL-5 |
| | Complete | | REL-6) | | REL-6 |
| DL capability with | OP | | Enumerated(32 kbps, | | REL-5 |
| simultaneous HS- | | | 64 kbps, 128 kbps, | | |
| DSCH | | | 384 kbps) | | |
| configuration | | | | | |
| PDCP capability | MP | | PDCP capability | | |
| | | | 10.3.3.24 | | |
| RLC capability | MP | | RLC capability | | |
| | | | 10.3.3.34 | | |
| Transport channel | MP | | Transport channel | | |
| capability | | | capability 10.3.3.40 | | |
| RF capability FDD | OP | | RF capability FDD | | |
| | | | 10.3.3.33 | | |
| RF capability TDD | OP | | RF capability TDD | One “TDD RF capability” entity | |
| | | | 10.3.3.33b | shall be included for every Chip | |
| | | | | rate capability supported. | |
| | | 1 to 2 | | | REL-4 |
| RF capability I- | OP | | I-WLAN RF | | REL-7/8 |
| WLAN | | | capability x.x.x | | |
| RF capability | OP | | WiMAx RF | | REL-7/8 |
| WiMAX | | | capability x.x.x | | |
| RF capability | OP | | Fixed Broadband | | REL-7/8 |
| Fixed Broadband | | | RF capability x.x.x | | |
| Physical channel | MP | | Physical channel | | |
| capability | | | capability 10.3.3.25 | | |
| UE multi- | MP | | UE multi- | | |
| mode/multi-RAT | | | mode/multi-RAT | | |
| capability | | | capability 10.3.3.41 | | |
| Security capability | MP | | Security capability | | |
| | | | 10.3.3.37 | | |
| UE positioning | MP | | UE positioning | | |
| capability | | | capability 10.3.3.45 | | |
| Measurement | CH- | | Measurement | | |
| capability | fdd_req_sup | | capability 10.3.3.21 | | |

| Condition | Explanation |
|---|---|
| fdd_req_sup | The IE is mandatory present if the IE “Multi-mode |
| | capability” has the value “FDD” or “FDD/TDD” and a FDD |
| | capability update has been requested in a previous message. |
| | Otherwise this field is not needed in the message. |
| not_rrc_connectionSetupComplete | The IE is not needed in the RRC CONNECTION SETUP |
| | COMPLETE message. Otherwise the IE is mandatory |
| | present. |

The UE may send radio access capability extension (defined in 3GPP TS 10.3.3.42a). The radio access capability extension may include supported frequency band information, (e.g., I-WLAN bands, WiMAX bands, fixed broadband bands, etc.). Table 3 shows UE radio access capability extension information including new information elements (underlined) pertaining the non-3GPP technologies.

TABLE 3

| Information | | | | | |
|---|---|---|---|---|---|
| Element/Group | | | Type and | Semantics | |
| name | Need | Multi | reference | description | Version |
| Frequency band | MP | 1 to | | | |
| specific capability list | | <maxFreqbandsFDD> | | | |
| >Frequency band | MP | | Enumerated(Band I, | One spare value is | |
| | | | Band II, | needed | |
| | | | Band III, | | REL-5 |
| | | | Band VI, Band IV, | | REL-6/7/8 |
| | | | Band V, | | |
| | | | I-WLAN bands, | | |
| | | | WiMAX Bands, | | |
| | | | Fixed Broadband | | |
| | | | Bands | | |
| >Frequency band 2 | OP | | Enumerated(Extension | This IE indicates | REL-6 |
| | | | Indicator | the supported | |
| | | | I-WLAN bands, | frequency bands | |
| | | | WiMAX Bands, | beyond Band VIII | |
| | | | Fixed Broadband | (yet to be defined) | |
| | | | Bands | Fifteen spare | |
| | | | | values are needed | |
| >RF capability FDD | MD | | RF capability FDD | the default values | |
| extension | | | extension 10.3.3.33a | are the same values | |
| | | | | as in the | |
| | | | | immediately | |
| | | | | preceding IE “RF | |
| | | | | capability FDD | |
| | | | | extension”; the first | |
| | | | | occurrence is MP | |
| >Measurement | MP | | Measurement | | |
| capability extension | | | capability extension | | |
| | | | 10.3.3.21a | | |
| >RF capability I- | MD | | RF capability I- | | |
| WLAN | | | WLAN | | |
| >Measurement | MP | | Measurement | | |
| capability I-WLAN | | | capability I-WLAN | | |
| >RF capability | MD | | RF capability WiMAx | | |
| WiMAX | | | | | |
| >Measurement | MP | | Measurement | | |
| capability WiMAX | | | capability WiMAx | | |
| >RF capability Fixed | MD | | RF capability Fixed | | |
| Broadband | | | Broadband | | |
| >Measurement | MP | | Measurement | | |
| capability Fixed | | | capability Fixed | | |
| Broadand | | | Broadband | | |

The 3GPP network sends CN information including CN domain identity (defined in 3GPP TS 25.331 10.3.1.1). The CN domain identity identifies the type of core network domain. The CN domain identity may further include types of non-3GPP domains (e.g., trusted or non-trusted: I-WLAN domain, WiMAX domain). The new information elements (underlined) are shown in Table 4.

TABLE 4

| Information | | | |
|---|---|---|---|
| Element/Group name | Need | Multi | Type and reference |
| CN domain identity | MP | | Enumerated (CS domain, PS |
| | | | domain, Non-3GPP |
| | | | domain (Trusted/Non-trusted: |
| | | | I-WLAN domain, WiMAX |
| | | | domain |

The 3GPP network sends CN information including CN domain system information (defined in 3GPP TS 25.331 10.3.1.2). The CN domain system information may include information pertaining to the non-3GPP network, such as CN domain specific I-WLAN system information (trusted and untrusted), CN domain specific WiMAX system information, CN domain specific fixed broadband system information. The CN domain system information including the new information elements (underlined) are shown in Table 5.

TABLE 5

| Information Element/Group name | Need | Type and reference |
|---|---|---|
| CN domain identity | MP | CN domain identity 10.3.1.1 |
| CHOICE CN Type | MP | |
| >GSM-MAP | | |
| >>CN domain specific NAS system | MP | NAS system information (GSM-MAP) |
| information | | 10.3.1.9 |
| >ANSI-41 | | |
| >>CN domain specific NAS system | MP | ANSI-41 NAS system information, |
| information | | 10.3.9.4 |
| Non-3GPP Network | | |
| >I-WLAN (Trusted) | | |
| >>CN domain specific I-WLAN system | MP | NAS system information (I-WLAN) |
| information | | 10.3.1.9 x |
| >I-WLAN (Non-Trusted) | | |
| >>CN domain specific I-WLAN system | MP | NAS system information (I-WLAN) |
| information | | 10.3.1.9 x |
| >WiMAX (Trusted) | | |
| >>CN domain specific WiMAX system | MP | NAS system information (WiMAX) |
| information | | 10.3.1.9 x |
| >Fixed Broadband (Non-Trusted) | | |
| >>CN domain specificFixed Broadband | MP | NAS system information (Fixed |
| system information | | Broadband 10.3.1.9 x |

The 3GPP network may provide the UE with domain specific access restriction parameters (defined in 3GPP TS 25.331 10.3.1.3c). Domain specific access restriction parameters specify domain specific access class restriction parameters for circuit switched (CS) and packet switched (PS) domain. This information element may further include parameters pertaining to the non-3GPP networks, such as domain specific access restriction parameters for trusted I-WLAN domain, non-trusted I-WLAN domain, WiMAX domain, fixed broadband domain, etc. Domain specific access restriction parameters including the new information elements (underlined) are shown in Table 6.

TABLE 6

| Information | | | | |
|---|---|---|---|---|
| Element/Group | | Type and | | |
| name | Need | reference | Semantics description | Version |
| CS Domain Specific | MP | Domain | This IE contains Domain Specific | REL-6 |
| Access Restriction | | Specific Access | Access Restriction Parameters for | |
| | | Restriction | CS domain. | |
| | | 10.3.1.3b | | |
| PS Domain Specific | MP | Domain | This IE contains Domain Specific | REL-6 |
| Access Restriction | | Specific Access | Access Restriction Parameters for | |
| | | Restriction | PS domain. | |
| | | 10.3.1.3b | | |
| I-WLAN (Trusted) | MP | Domain | This IE contains Domain Specific | REL-7/8 |
| Domain Specific Access | | Specific Access | Access Restriction Parameters for | |
| Restriction | | Restriction | Trusted I-WLAN domain. | |
| | | 10.3.1.3b X | | |
| I-WLAN (Non-Tusted) | MP | Domain | This IE contains Domain Specific | REL-7/8 |
| Domain Specific Access | | Specific Access | Access Restriction Parameters | |
| Restriction | | Restriction | forNon-Trusted I-WLAN domain. | |
| | | 10.3.1.3b X | | |
| WiMAX (Trusted) | MP | Domain | This IE contains Domain Specific | REL-7/8 |
| Domain Specific Access | | Specific Access | Access Restriction Parameters for | |
| Restriction | | Restriction | WiMAX domain. | |
| | | 10.3.1.3b X | | |
| Fixed Broadband | MP | Domain | This IE contains Domain Specific | REL-7/8 |
| Domain Specific Access | | Specific Access | Access Restriction Parameters for | |
| Restriction | | Restriction | Fixed Broadband domain. | |
| | | 10.3.1.3b X | | |

The 3GPP network provides the UE with intra domain NAS node selector (defined in 3GPP TS 25.331 10.3.1.6). The intra-domain NAS node selector information element carries information to be used to route the establishment of a signaling connection to a CN node within a CN domain. This information element may further include information pertaining to the non-3GPP networks, such as routing parameters for the I-WLAN (trusted or untrusted), WiMAX (trusted), fixed broadband network, etc. The intra domain NAS node selector including the new information elements (underlined) is shown in Table 7.

TABLE 7

| Information | | Type and | |
|---|---|---|---|
| Element/Group name | Need | reference | Semantics description |
| CHOICE version | MP | | |
| >R99 | | | This choice shall also be used by mobiles that |
| | | | are compliant to this version of the protocol |
| >>CHOICE CN type | MP | | |
| >>>GSM-MAP | | | |
| >>>>CHOICE Routing | MP | | |
| basis | | | |
| >>>>>local (P)TMSI | | | TMSI allocated in the current LA or PTMSI |
| | | | allocated in the current RA |
| >>>>>>Routing | MP | Bit string | The TMSI/PTMSI consists of 4 octets (32bits). |
| parameter | | (10) | This can be represented by a string of bits |
| | | | numbered from b0 to b31, with bit b0 being the |
| | | | least significant |
| | | | The “Routing parameter” bit string consists of |
| | | | bits b14 through b23 of the TMSI/PTMSI. The |
| | | | first/leftmost/most significant bit of the bit |
| | | | string contains bit b23 of the TMSI/PTMSI. |
| >>>>>(P)TMSI of same | | | TMSI allocated in another LA of this PLMN or |
| PLMN, different | | | PTMSI allocated in another RA this PLMN |
| (RA)LA | | | |
| >>>>>>Routing | MP | Bit string | The TMSI/PTMSI consists of 4 octets (32bits). |
| parameter | | (10) | This can be represented by a string of bits |
| | | | numbered from b0 to b31, with bit b0 being the |
| | | | least significant |
| | | | The “Routing parameter” bit string consists of |
| | | | bits b14 through b23 of the TMSI/PTMSI. The |
| | | | first/leftmost/most significant bit of the bit |
| | | | string contains bit b23 of the TMSI/PTMSI. |
| >>>>>(P)TMSI of | | | TMSI or a PTMSI allocated in another PLMN |
| different PLMN | | | |
| >>>>>>Routing | MP | Bit string | The TMSI/PTMSI consists of 4 octets (32bits). |
| parameter | | (10) | This can be represented by a string of bits |
| | | | numbered from b0 to b31, with bit b0 being the |
| | | | least significant. |
| | | | The “Routing parameter” bit string consists of |
| | | | bits b14 through b23 of the TMSI/PTMSI. The |
| | | | first/leftmost/most significant bit of the bit |
| | | | string contains bit b23 of the TMSI/PTMSI. |
| >>>>>IMSI(response to | | | NAS identity is IMSI |
| IMSI paging) | | | |
| >>>>>>Routing | MP | Bit string | The “Routing parameter” bit string consists of |
| parameter | | (10) | DecimalToBinary [(IMSI div 10) mod 1000]. The |
| | | | first/leftmost bit of the bit string contains the |
| | | | most significant bit of the result. |
| >>>>>IMSI(cause UE | | | NAS identity is IMSI |
| initiated event) | | | |
| >>>>>>Routing | MP | Bit string | The “Routing parameter” bit string consists of |
| parameter | | (10) | DecimalToBinary [(IMSI div 10) mod 1000]. The |
| | | | first/leftmost bit of the bit string contains the |
| | | | most significant bit of the result. |
| >>>>>IMEI | | | NAS parameter is IMEI |
| >>>>>>Routing | MP | Bit string | The “Routing parameter” bit string consists of |
| parameter | | (10) | DecimalToBinary [(IMEI div 10) mod 1000]. |
| | | | The first/leftmost bit of the bit string contains |
| | | | the most significant bit of the result. |
| >>>>>Spare 1 | | Bit string | This choice shall not be used in this version |
| | | (10) | |
| >>>>>Spare 2 | | Bit string | This choice shall not be used in this version |
| | | (10) | |
| >>>ANSI-41 | | Bit string | All bits shall be set to 0 |
| | | (14) | |
| >>>I-WLAN (Trusted) | | Bit string | All bits shall be set to 1 |
| | | (14) | |
| >>>I-WLAN (Non- | | Bit string | All bits shall be set to 1 |
| Trusted) | | (14) | |
| >>>WiMAX (Trusted) | | Bit string | All bits shall be set to 1 |
| | | (14) | |
| >>>Fixed Broadband | | Bit string | All bits shall be set to 1 |
| | | (14) | |
| >Later | | Bit | This bit string shall not be sent by mobiles that |
| | | string(15) | are compliant to this version of the protocol. |

The 3GPP network provides the UE with NAS system information (defined in 3GPP TS 25.331 10.3.1.9). The NAS system information (GSM-MAP) shown in Table 8 contains system information that belongs to the NAS for a GSM-MAP type of PLMN. This information is transparent to radio resource control (RRC). This information element may contain either information specific to one CN domain (CS or PS, or non-3GPP (I-WLAN, WiMAx, or fixed broadband)) or information common for both CN domains.

TABLE 8

| Information | | Type and | |
|---|---|---|---|
| Element/Group name | Need | reference | Semantics description |
| GSM-MAP NAS system | MP | Octet | The first octet contains octet 1 [5] of the |
| information | | string(1 . . . 8) | NAS system information element, the |
| | | | second octet contains octet 2 of the NAS |
| | | | system information element and so on. |
| I-WLAN NAS system | MP | Octet String | |
| information | | (1 . . . 8) | |

The 3GPP network provides the UE with a PLMN type information (defined in 3GPP TS 25.331 10.3.1.12). The “PLMN type” information element identifies the type of PLMN. This information element shall be used to control the interpretation of network dependent messages and information elements in the RRC protocol. “I-WLAN” is included as one of the PLMN type as shown in Table 9.

TABLE 9

| Information | | | |
|---|---|---|---|
| Element/ | | | Semantics |
| Group name | Need | Type and reference | description |
| PLMN Type | MP | Enumerated (GSM-MAP, | One spare value |
| | | ANSI-41, GSM-MAP and | is needed. |
| | | ANSI-41, I-WLAN) | |

The 3GPP network provides the UE with a radio access bearer (RAB) identity (as defined in 3GPP TS 25.331 10.3.1.14). The RAB identity uniquely identifies an RAB within a CN domain. The RAB identity information element may include an RAB identity of the I-WLAN (trusted or untrusted), WiMAX, fixed broadband, etc. The RAB identity information including the new information elements (underlined) are shown in Table 10.

TABLE 10

| Information | | Type and | |
|---|---|---|---|
| Element/Group name | Need | reference | Semantics description |
| CHOICE RAB identity type | MP | | |
| >RAB identity (GSM-MAP) | | Bit string | Formatted according to [5]. The |
| | | (8) | first/leftmost bit of the bit string contains the |
| | | | most significant bit of the RAB identity. |
| >RAB identity (ANSI-41) | | Bit string | The first/leftmost bit of the bit string |
| | | (8) | contains the most significant bit of the RAB |
| | | | identity. |
| >RAB identity (WLAN | | Bit string | The first/leftmost bit of the bit string |
| (Trusted)) | | (8) | contains the most significant bit of the RAB |
| | | | identity. |
| >RAB identity (WLAN | | Bit string | The first/leftmost bit of the bit string |
| Non-Trusted) | | (8) | contains the most significant bit of the RAB |
| | | | identity. |
| >RAB identity (WiMAx) | | Bit string | The first/leftmost bit of the bit string |
| | | (8) | contains the most significant bit of the RAB |
| | | | identity. |
| >RAB identity (Fixed | | Bit string | The first/leftmost bit of the bit string |
| Broadband) | | (8) | contains the most significant bit of the RAB |
| | | | identity. |

| | Condition under which the given RAB |
|---|---|
| CHOICE NAS binding info type | identity type is chosen |
| RAB identity (GSM-MAP) | PLMN is of type GSM-MAP |
| RAB identity (ANSI-41) | PLMN is of type ANSI-41 |
| RAB identity (WLAN) | PLMN is of type WLAN |

The UE reports its measurement capabilities to the network (as defined in 3GPP TS 25.331 10.3.3.21). The UE may indicate to the 3GPP network through the measurement capability information element whether the UE requires downlink or uplink compressed mode in order to perform measurements on IEEE 802.11 WLAN or IEEE 802.16 WLAN. The measurement capability information including the new information elements (underlined) is shown in Table 11.

TABLE 11

| Information | | Type and | | |
|---|---|---|---|---|
| Element/Group name | Need | reference | Semantics description | Version |
| Need for downlink | | | | |
| compressed mode | | | | |
| FDD measurements | MP | Boolean | TRUE means that the UE | |
| | | | requires DL compressed mode in | |
| | | | order to perform measurements | |
| | | | on FDD | |
| 3.84 Mcps TDD | CV- | Boolean | TRUE means that the UE | Name |
| measurements | 3.84_Mcps_tdd_sup | | requires DL compressed mode in | changed in |
| | | | order to perform measurements | REL-4 |
| | | | on 3.84 Mcps TDD | |
| 1.28 Mcps TDD | CV- | Boolean | TRUE means that the UE | REL-4 |
| measurements | 1.28_Mcps_tdd_sup | | requires DL compressed mode in | |
| | | | order to perform measurements | |
| | | | on 1.28 Mcps TDD | |
| GSM measurements | CV- | | | |
| | gsm_sup | | | |
| >GSM 900 | MP | Boolean | TRUE means that the UE | |
| | | | requires DL compressed mode in | |
| | | | order to perform measurements | |
| | | | on GSM 900 | |
| >DCS 1800 | MP | Boolean | TRUE means that the UE | |
| | | | requires DL compressed mode in | |
| | | | order to perform measurements | |
| | | | on DCS 1800 | |
| >GSM 1900 | MP | Boolean | TRUE means that the UE | |
| | | | requires DL compressed mode in | |
| | | | order to perform measurements | |
| | | | on GSM 1900 | |
| Multi-carrier measurement | CV- | Boolean | TRUE means that the UE | |
| | mc_sup | | requires DL compressed mode in | |
| | | | order to perform measurements | |
| | | | on multi-carrier | |
| WLAN measurements | | | | |
| >802.11 | MP | Boolean | TRUE means that the UE | |
| | | | requires DL compressed mode in | |
| | | | order to perform measurements | |
| | | | on WLAN 802.11 | |
| >802.16 | MP | Boolean | TRUE means that the UE | |
| | | | requires DL compressed mode in | |
| | | | order to perform measurements | |
| | | | on WLAN 802.16 | |
| 3.84 Mcps TDD | CV- | Boolean | TRUE means that the UE | Name |
| measurements | 3.84_Mcps_tdd_sup | | requires UL compressed mode in | changed in |
| | | | order to perform measurements | REL-4 |
| | | | on 3.84 Mcps TDD | |
| 1.28 Mcps TDD | CV- | Boolean | TRUE means that the UE | REL-4 |
| measurements | 1.28_Mcps_tdd_sup | | requires DL compressed mode in | |
| | | | order to perform measurements | |
| | | | on 1.28 Mcps TDD | |
| GSM measurements | CV- | | | |
| | gsm_sup | | | |
| >GSM 900 | MP | Boolean | TRUE means that the UE | |
| | | | requires UL compressed mode in | |
| | | | order to perform measurements | |
| | | | on GSM 900 | |
| >DCS 1800 | MP | Boolean | TRUE means that the UE | |
| | | | requires UL compressed mode in | |
| | | | order to perform measurements | |
| | | | on DCS 1800 | |
| >GSM 1900 | MP | Boolean | TRUE means that the UE | |
| | | | requires UL compressed mode in | |
| | | | order to perform measurements | |
| | | | on GSM 1900 | |
| Multi-carrier measurement | CV- | Boolean | TRUE means that the UE | |
| | mc_sup | | requires UL compressed mode in | |
| | | | order to perform measurements | |
| | | | on multi-carrier | |
| WLAN measurements | | | | |
| >802.11 | MP | Boolean | TRUE means that the UE | |
| | | | requires UL compressed mode in | |
| | | | order to perform measurements | |
| | | | on WLAN 802.11 | |
| >802.16 | MP | Boolean | TRUE means that the UE | |
| | | | requires UL compressed mode in | |
| | | | order to perform measurements | |
| | | | on WLAN 802.16 | |

| Condition | Explanation |
|---|---|
| 3.84_Mcps_tdd_sup | The IE is mandatory present if an IE “TDD RF capability” |
| | is present with the IE “Chip rate capability” set to “3.84 |
| | Mcps”. Otherwise this field is not needed in the message. |
| 1.28_Mcps_tdd_sup | The IE is mandatory present if an IE “TDD RF capability” |
| | is present with the IE “Chip rate capability” set to “1.28 |
| | Mcps”. Otherwise this field is not needed in the message. |
| gsm_sup | The IE is mandatory present if the IE “Inter-RAT UE radio |
| | access capability” indicates support for GSM900, GSM1800 |
| | and/or GSM1900. Otherwise this field is not needed in the |
| | message. |
| mc_sup | The IE is mandatory present if the IE “Support of multi- |
| | carrier” has the value TRUE. Otherwise this field is not |
| | needed in the message. |

Measurement capability extension information element may be used to replace the measurement capability information provided within the measurement capability information element. The measurement capability extension information element indicates the need for downlink or uplink compressed mode to perform measurement on IEEE 802.11 or 802.16 WLAN, as shown in Table 12.

TABLE 12

| Information | | | | | |
|---|---|---|---|---|---|
| Element/Group | | | Type and | | |
| name | Need | Multi | reference | Semantics description | Version |
| FDD measurements | MP | 1 to | | | |
| | | <maxFreqBandsFDD> | | | |
| >FDD Frequency | MD | | Enumerated | The default value is the same | |
| band | | | (Band I, | as indicated in the IE | |
| | | | Band II, | “Frequency band” included in | |
| | | | | the IE “UE radio access | |
| | | | | capability extension”. Band | |
| | | | | numbering is defined in [21]. | |
| | | | | One spare value is needed | |
| | | | Band III, | | REL-5 |
| | | | Band VI, | The default value is the same | REL-6 |
| | | | Band IV, | as R99, if the IE “FDD | |
| | | | Band V) | Frequency band 2” below is | |
| | | | | not included. The default | |
| | | | | value is the same as the IE | |
| | | | | “FDD Frequency band 2”, if | |
| | | | | the IE “FDD Frequency band | |
| | | | | 2” is included. | |
| >FDD Frequency | MD | | Enumerated | The default value is the same | REL-6 |
| band 2 | | | (Extension | as indicated in the IE | |
| | | | Indicator) | “Frequency band 2” included | |
| | | | | in the IE “UE radio access | |
| | | | | capability extension”., if the | |
| | | | | IE “FDD Frequency band” | |
| | | | | above is not included. The | |
| | | | | default value is the same as | |
| | | | | the IE “FDD Frequency band”, | |
| | | | | if the IE “FDD Frequency | |
| | | | | band” is included. | |
| | | | | Fifteen spare values are | |
| | | | | needed | |
| >Need for DL | MP | | Boolean | TRUE means that the UE | |
| compressed mode | | | | requires DL compressed mode | |
| | | | | in order to perform | |
| | | | | measurements on the FDD | |
| | | | | frequency band indicated by | |
| | | | | the IE “FDD Frequency band” | |
| >Need for UL | MP | | Boolean | TRUE means that the UE | |
| compressed mode | | | | requires UL compressed mode | |
| | | | | in order to perform | |
| | | | | measurements on the FDD | |
| | | | | frequency band indicated by | |
| | | | | the IE “FDD Frequency band” | |
| TDD measurements | CV- | 1 to | | | |
| | tdd_sup | <maxFreqBandsTDD> | | | |
| >TDD Frequency | MP | | Enumerated | | |
| band | | | (a, b, c) | | |
| >Need for DL | MP | | Boolean | TRUE means that the UE | |
| compressed mode | | | | requires DL compressed mode | |
| | | | | in order to perform | |
| | | | | measurements on TDD | |
| | | | | frequency band indicated by | |
| | | | | the IE “TDD Frequency band” | |
| >Need for UL | MP | | Boolean | TRUE means that the UE | |
| compressed mode | | | | requires UL compressed mode | |
| | | | | in order to perform | |
| | | | | measurements on TDD | |
| | | | | frequency band indicated by | |
| | | | | the IE “TDD Frequency band” | |
| GSM measurements | CV- | 1 to | | | |
| | gsm_sup | <maxFreqBandsGSM> | | | |
| >GSM Frequency | MP | | Enumerated | as defined in [45]. | |
| band | | | (GSM450, | Nine spare values are needed. | |
| | | | GSM480, | | |
| | | | GSM850, | | |
| | | | GSM900P, | | |
| | | | GSM900E, | | |
| | | | GSM1800, | | |
| | | | GSM1900) | | |
| >Need for DL | MP | | Boolean | TRUE means that the UE | |
| compressed mode | | | | requires DL compressed mode | |
| | | | | in order to perform | |
| | | | | measurements on GSM | |
| | | | | frequency band indicated by | |
| | | | | the IE “GSM Frequency band” | |
| >Need for UL | MP | | Boolean | TRUE means that the UE | |
| compressed mode | | | | requires UL compressed mode | |
| | | | | in order to perform | |
| | | | | measurements on GSM | |
| | | | | frequency band indicated by | |
| | | | | the IE “GSM Frequency band” | |
| Multi-carrier | CV- | | | | |
| measurement | mc_sup | | | | |
| >Need for DL | MP | | Boolean | TRUE means that the UE | |
| compressed mode | | | | requires DL compressed mode | |
| | | | | in order to perform | |
| | | | | measurements on multi- | |
| | | | | carrier | |
| >Need for UL | MP | | Boolean | TRUE means that the UE | |
| compressed mode | | | | requires UL compressed mode | |
| | | | | in order to perform | |
| | | | | measurements on multi- | |
| | | | | carrier | |
| WLAN | | | | | |
| measurements | | | | | |
| >WLAN 802.11 | MP | | Enumerated | as defined in [802.11a]. | |
| Frequency band | | | (x, y, z) | | |
| >Need for DL | MP | | Boolean | TRUE means that the UE | |
| compressed mode | | | | requires DL compressed mode | |
| | | | | in order to perform | |
| | | | | measurements on WLAN | |
| | | | | 802.11 | |
| >Need for UL | MP | | Boolean | TRUE means that the UE | |
| compressed mode | | | | requires UL compressed mode | |
| | | | | in order to perform | |
| | | | | measurements on WLAN | |
| | | | | 802.11 | |
| >WLAN 802.16 | MP | | Enumerated | as defined in [802.16]. | |
| Frequency band | | | (x, y, z) | | |
| >Need for DL | MP | | Boolean | TRUE means that the UE | |
| compressed mode | | | | requires DL compressed mode | |
| | | | | in order to | |
| | | | | measurements on WLAN | |
| | | | | 802.16 | |
| >Need for UL | MP | | Boolean | TRUE means that the UE | |
| compressed mode | | | | requires UL compressed mode | |
| | | | | in order to perform | |
| | | | | measurements on WLAN | |
| | | | | 802.16 | |

| Condition | Explanation |
|---|---|
| tdd_sup | The IE is mandatory present if the IE “Multi-mode |
| | capability” has the value “TDD” or “FDD/TDD”. Otherwise |
| | this field is not needed in the message. |
| gsm_sup | The IE is mandatory present if the IE “Support of GSM” |
| | has the value TRUE. Otherwise this field is not needed in |
| | the message. |
| mc_sup | The IE is mandatory present if the IE “Support of multi- |
| | carrier” has the value TRUE. Otherwise this field is not |
| | needed in the message. |

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for providing capability information and core network information to support interworking between a third generation partnership project (3GPP) network and a non-3GPP network, the method comprising:
registering with a 3GPP network; and
sending user equipment (UE) capability information pertaining to the non-3GPP network to the 3GPP network.

2. The method of claim 1 wherein the non-3GPP network is at least one of an 802.11 interworking wireless local area network (I-WLAN), an 802.16 WiMAX network, and a fixed broadband network.

3. The method of claim 1 wherein the UE capability information pertaining to the non-3GPP network includes at least one of UE multi-mode/multi-radio access technology (RAT) capability, UE radio access capability, and UE measurement capability.

4. The method of claim 3 wherein the UE multi-mode/multi-RAT capability information includes at least one of support for trusted interworking wireless local area network (I-WLAN), support of non-trusted I-WLAN, support of trusted WiMAX network, and support of trusted fixed broadband network, support of I-WLAN-universal terrestrial radio access network (UTRAN) handoff, support of WiMAX-UTRAN handoff, and support of fixed broadband-UTRAN handoff.

5. The method of claim 3 wherein the UE radio access capability information includes at least one of interworking wireless local area network (I-WLAN) radio frequency (RF) capability, WiMAX RF capability, and fixed broadband RF capability.

6. The method of claim 5 wherein the UE radio access capability information further includes supported frequency band information.

7. The method of claim 1 further comprising:
receiving core network information pertaining to the non-3GPP networks from the 3GPP network.

8. The method of claim 7 wherein the core network information pertaining to the non-3GPP networks includes at least one of core network domain identity, core network domain system information, domain specific access restriction, domain specific access restriction parameters, intra domain non-access stratum (NAS) node selector, NAS system information, public land mobile network (PLMN) type, and radio access bearer (RAB) identity.

9. A user equipment (UE) for providing capability information to support interworking between a third generation partnership project (3GPP) network and a non-3GPP network, the UE comprising:
a 3GPP radio unit;
a non-3GPP radio unit; and
a controller for sending UE capability information pertaining to a non-3GPP network to a 3GPP network.

10. The UE of claim 9 wherein the non-3GPP network is at least one of an 802.11 interworking wireless local area network (I-WLAN), an 802.16 WiMAX network, and a fixed broadband network.

11. The UE of claim 9 wherein the UE capability information pertaining to the non-3GPP network includes at least one of UE multi-mode/multi-radio access technology (RAT) capability, UE radio access capability, and UE measurement capability.

12. The UE of claim 11 wherein the UE multi-mode/multi-RAT capability information includes at least one of support for trusted interworking wireless local area network (I-WLAN), support of non-trusted I-WLAN, support of trusted WiMAX network, and support of trusted fixed broadband network, support of I-WLAN-universal terrestrial radio access network (UTRAN) handoff, support of WiMAX-UTRAN handoff, and support of fixed broadband-UTRAN handoff.

13. The UE of claim 11 wherein the UE radio access capability information includes at least one of interworking wireless local area network (I-WLAN) radio frequency (RF) capability, WiMAX RF capability, and fixed broadband RF capability.

14. The UE of claim 13 wherein the UE radio access capability information further includes supported frequency band information.

15. The UE of claim 9 wherein the controller is configured to receive core network information pertaining to the non-3GPP networks from the 3GPP network.

16. The UE of claim 15 wherein the core network information pertaining to the non-3GPP networks includes at least one of core network domain identity, core network domain system information, domain specific access restriction, domain specific access restriction parameters, intra domain non-access stratum (NAS) node selector, NAS system information, public land mobile network (PLMN) type, and radio access bearer (RAB) identity.

17. A method for providing capability information and core network information to support interworking between a third generation partnership project (3GPP) network and a non-3GPP network, the method comprising:
receiving user equipment (UE) capability information pertaining to the non-3GPP network from a UE; and
sending core network information pertaining to the non-3GPP network to the UE.

18. The method of claim 17 wherein the non-3GPP network is at least one of an 802.11 interworking wireless local area network (I-WLAN), an 802.16 WiMAX network, and a fixed broadband network.

19. The method of claim 17 wherein the UE capability information pertaining to the non-3GPP network includes at least one of UE multi-mode/multi-radio access technology (RAT) capability, UE radio access capability, and UE measurement capability.

20. The method of claim 17 wherein the core network information pertaining to the non-3GPP networks includes at least one of core network domain identity, core network domain system information, domain specific access restriction, domain specific access restriction parameters, intra domain non-access stratum (NAS) node selector, NAS system information, public land mobile network (PLMN) type, and radio access bearer (RAB) identity.

21. An apparatus for providing capability information and core network information to support interworking between a third generation partnership project (3GPP) network and a non-3GPP network, the apparatus comprising:
a transceiver; and
a processing unit for receiving user equipment (UE) capability information pertaining to the non-3GPP network from a UE and sending core network information pertaining to the non-3GPP network to the UE.

22. The apparatus of claim 21 wherein the non-3GPP network is at least one of an 802.11 interworking wireless local area network (I-WLAN), an 802.16 WiMAX network, and a fixed broadband network.

23. The apparatus of claim 21 wherein the UE capability information pertaining to the non-3GPP network includes at least one of UE multi-mode/multi-radio access technology (RAT) capability, UE radio access capability, and UE measurement capability.

24. The apparatus of claim 21 wherein the core network information pertaining to the non-3GPP networks includes at least one of core network domain identity, core network domain system information, domain specific access restriction, domain specific access restriction parameters, intra domain non-access stratum (NAS) node selector, NAS system information, public land mobile network (PLMN) type, and radio access bearer (RAB) identity.
